(19) United States
(12) Patent Application Publication
(10) Pub. No.: US 2017/0000301 A1
(43) Pub. Date: Jan. 5, 2017

(54) WASTE MATERIAL DISCHARGING DEVICE IN A SANITARY APPLIANCE

(71) Applicant: Alessio Dainelli, San Gimignano, (SI) (IT)

(72) Inventor: Alessio Dainelli, San Gimignano, (SI) (IT)

(21) Appl. No.: 14/902,479

(22) PCT Filed: Jul. 2, 2014
(86) PCT No.: PCT/IB2014/062792

§ 371 Date: Dec. 31, 2015

(30) Foreign Application Priority Data
Jul. 2, 2013 (IT) PI2013A000062

(51) Int. Cl. A47K 11/02; B05B 11/00; A47K 11/10

(52) U.S. Cl. CPC A47K 11/02; A47K 11/10; B05B 11/3009

(57) ABSTRACT

A waste material discharging device in a sanitary appliance comprising a seat (1) and a vessel, to which the seat is pivotally connected, having an opening for conveying and collecting the waste material. The device comprises a roller (4) rotatable in only one direction about its axis, integral to the seat (1) and placed therebelow at said opening, scraping means (5) stationarily arranged parallel to the roller (4) and substantially in contact to the surface of said roller, driving means (11), operable by a user, for driving unidirectional and intermittent, axial angular displacements to the roller, and means for dispensing (15, 18) a cleansing and sanitizing liquid, directed toward the surface of the roller (4) and driven by the same roller rotation driving means (11).

### FIELD OF THE INVENTION

The present invention relates to the field of sanitary appliances. More particularly, the invention relates to the field of sanitary appliances designed to be installed on mobile structures, such as vehicles in general, or, anyway, structures that are likely to be moved from one installation place to another. In particular, the invention relates to a device for the discharge of human waste material designed for use in a sanitary appliance of the abovementioned type.

### BACKGROUND OF THE INVENTION

Human waste material discharging devices usable in sanitary appliances of the abovementioned type are known. In such devices the operation of the relevant driving mechanisms depends on the availability of power and/or water sources for cleaning the appliance after use. When both power and water are not available, a fully manual working of the device is often associated to a relatively complex structure and mechanism that may negatively affect the cleaning and maintenance operations. Therefore, it is a very felt need in the field for a waste material discharging device having a very simple structure and low cost as well as easy to work. Another especially felt need is that the device would not hinder the appliance maintenance operations. In fact, as provided in the know art, it is convenient that the device be configured such that, in use, the underlying part of the sanitary appliance for conveying and/or collecting the waste material located below the annular seat for the user would not be in sight through the relevant hole. On the other hand, it is also important that meeting such needs would not complicate the periodic maintenance operations of the apparatus carried out by maintenance staff. In particular, it is important that the waste material conveying and/or collecting structures would be easily accessible or, anyway, no complex structural arrangements to the device or the apparatus be required to make such access possible.

U.S. Pat. No. 5,345,620 discloses a human waste material discharging device in a sanitary appliance comprising a seat and a vessel, to which the seat is pivotally connected, having an opening for conveying and collecting the waste material.

### SUMMARY OF THE INVENTION

The general object of the present invention is to provide a device for the discharge of human waste material of a sanitary appliance that enables the abovementioned drawbacks of the prior art devices to be avoided.

A particular object of the present invention is to provide a device of the above mentioned type in which waste discharge and a complete cleaning and sanitization are performed at the same time as a result of a single user motion, for example a repeated pedal depression.

Another object of the present invention is to provide a device of the above mentioned type in which maintenance operations can be carried out in a very simple way.

These objects are attained with the waste material discharging device in a sanitary appliance according to the invention the essential features of it are set forth in claim 1. Further important features of the invention are set forth in the dependent claims.

According to an important feature of the invention, the device comprises a roller rotatable in only one direction about its axis, integral to the seat of the sanitary appliance and placed therebelow at the opening of the waste material conveying and/or collecting structure, scraping means stationarily arranged parallel to the roller and substantially in contact to the surface of the roller, driving means, operable by a user, for driving unidirectional and intermittent, axial angular displacements to the roller, and means for dispensing a cleansing and sanitizing liquid, directed toward the surface of the roller and driven by the same roller rotation driving means.

According to a preferred solution of the invention the driving means comprise a pedal pivotally connected to a fixed base and angularly displaceable by pressure in opposition to elastic means, and free wheel transmission means are provided between the pedal and the roller for causing the roller to perform the intermittent, axial angular displacements following corresponding angular displacements of the pedal.

According to a further preferred solution of the invention, the transmission means comprise a shaft and a transmission joint integral to the roller, the shaft engaging with said joint. The joint has a cross-section with a substantially C-shaped profile, whereby when the opening defined by this profile is turned downwards, the shaft can be disengaged from the joint, thus causing the seat to be raised. In this way, by exploiting suitable reference marks formed on the roller surface and the fixed structure, the operator can depress the pedal and easily position the roller in such a way that the joint opening faces downward, thereby causing the shaft to be disengaged. The contemporaneous raising of both the seat and the roller connected thereto clears the inlet of the underlying waste conveying and/or collecting structure of the sanitary appliance and in this way it is possible to reach the inside of it for periodic maintenance.

### BRIEF DESCRIPTION OF THE DRAWINGS

The above and other features, as well as the and advantages of the human waste discharging device in a sanitary appliance according to the present invention will be apparent from the following description of an exemplifying, non-limiting embodiment thereof with reference to the attached drawings, in which:

FIG. 1 is a perspective view of the device according to the invention;

FIG. 2 is a top plan view of the device of FIG. 1;

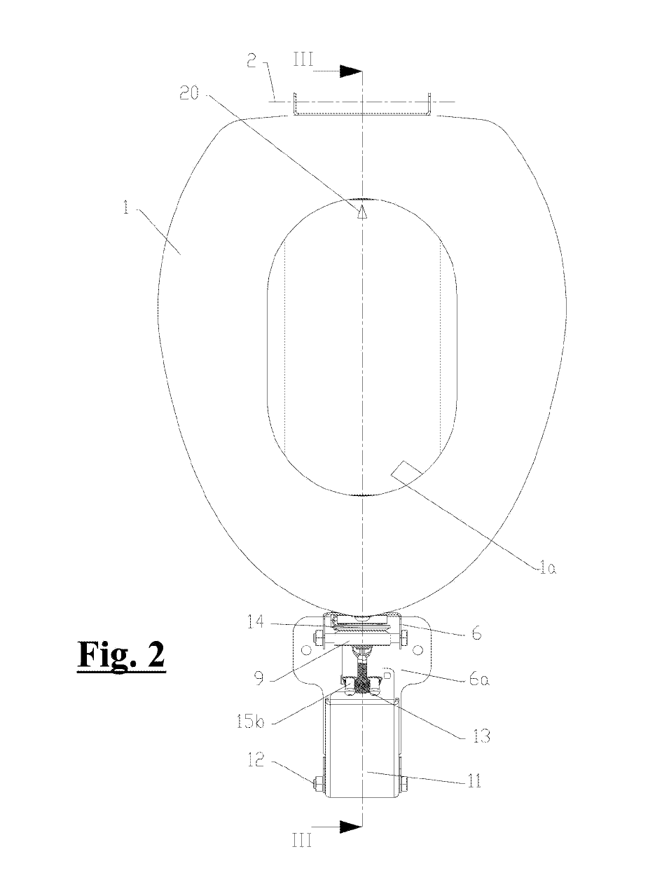

FIG. 3 is side cross-sectional view taken along line III-III of FIG. 2 of the device according to the invention;

FIG. 4 is a front view of the device according to the invention;

FIG. 5 in an enlarged, sectional view of a particular of the device according to the invention;

FIG. 6 is a partial, perspective view of the device in a pedal end-stroke condition.

### DETAILED DESCRIPTION OF THE INVENTION

With reference to the abovementioned figures, it has been indicated at 1 a toilet seat of a sanitary appliance (not shown) of any known type. The seat is pivotally connected, in an equally known way, to the bowl of the sanitary appliance or, more generally, to the waste conveying/collecting vessel, so that it can be rotated about an horizontal axis 2 to enable it to be raised.

The seat 2 has a well-known, annular- or ring-shaped configuration delimited by an inner edge 1a, with two substantially parallel brackets 3 extending therefrom below the mean lying plane of seat 1.

The two brackets 3 pivotally hold a roller 4 lying below seat 1. In use, the roller is housed in the chamber of a cup-shaped portion of the sanitary appliance, not shown, lying below seat 1 and communicating with a collecting device of the sanitary appliance, for example a tank, or a conveying device, for example a duct, for the human waste. In particular, the roller 4 is such sized as to engage the communication opening, or inlet, between the bowl and the collecting/conveying device so that said device is made hidden from view.

The two brackets 3 also hold a blade 5, or scraper, skimming the surface of the roller 4 and arranged generally parallel to the roller 4 at the side opposite to seat 1 with respect to roller 4.

A transmission joint 8 coaxially extends from roller 4 and a transmission shaft 7 engages within the joint 8, for example through a prismatic connection. Shaft 7 is pivotally held, in a position coaxial to roller 4, by an upright 6 that is fixable to a floor plane (not shown) by a base plate 6a on which the sanitary appliance assembly rests. The transmission joint 8 is arranged between one of the brackets 3 and the upright 6 and is integral to roller 4. The upright 6 is fixed to the structure of the sanitary appliance at its upper end, for example by a screw 19.

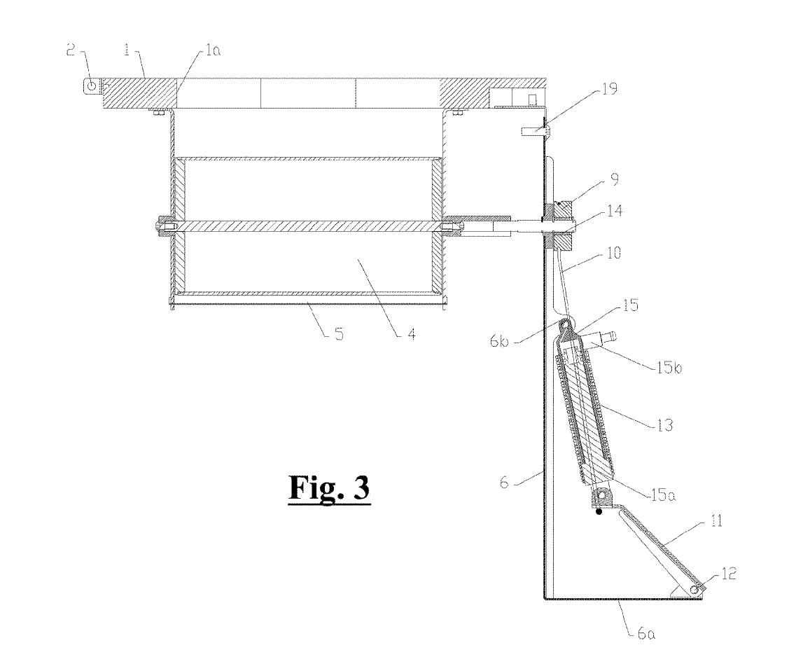

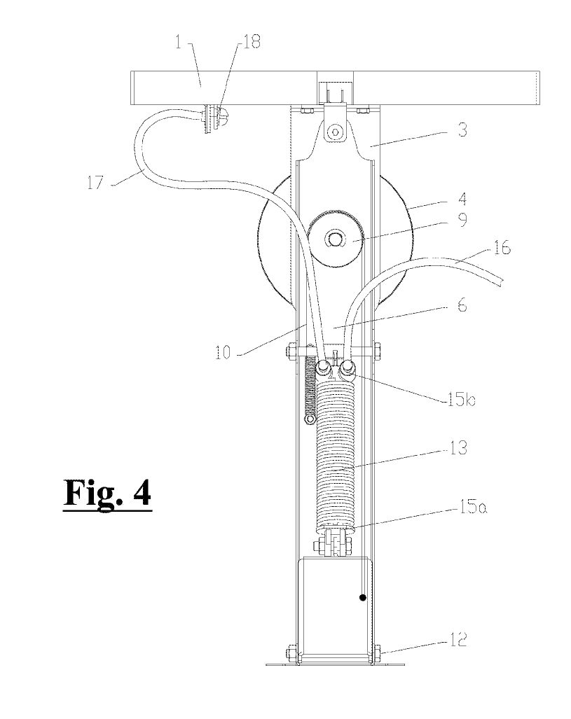

A pulley 9 is mounted on transmission shaft 7 through a free wheel 14, and flexible transmission means are engaged with pulley 9, for example a steel cable 10, visible in FIGS. 3 and 4, having one end fixed to the upright 6 and the other end fixed to a pedal 11 placed at the base 6a of the upright 6.

The pedal 11 is pivotally connected at 12 to the base 6a of the upright 6 with one of its sides, while the opposite side of pedal 11 is connected to a spring 13 extending from an intermediate point 6b of the upright 6.

A pump 15 also is connected to the upright 6 and is hinged at point 6b to which an end of spring 13 is connected. Pump 15 communicates with a tank (not shown) containing a cleansing and sanitizing liquid through a first conduit 16 and with a delivery nozzle 18 through a second conduit 17, the nozzle 18 being placed, for example, on the edge of the bowl of the sanitary appliance below the seat 1 and turned towards roller 4, or at another position suitable for dispensing the liquid on the surface of roller 4. In the present embodiment of the invention, pump 15 is a double effect piston pump. In this embodiment, piston 15a slides in a cylinder, forming the body of pump 15: the pressure reduction during the piston extension stroke causes the liquid to be sucked in, whereas the positive pressure generated during the piston retraction stroke causes the previously sucked liquid to be ejected. The piston 15a is hinged to pedal 11 at the end of its rod. Pump 15 is equipped with two check valves enabling the fluid to flow alternately in conduit 16 and in conduit 17, in order to suck liquid from its tank and, respectively, to direct it to the dispensing nozzle 18.

The motion of roller 4 intermittently proceeds in only one direction thanks to the connection between transmission shaft 7 and pulley 9 through the free wheel 14. As a matter of fact, when pedal 11 is depressed to work it, the presence of the free wheel 14 enables motion to be transmitted, through cable 10, thereby rotating roller 4. In contrast, when pedal 11 is released, spring 13 withdraws pedal 11 in its starting position, while free wheel 14 allows pulley 9 to idly rotate about the transmission shaft 7, thus ensuring that roller 4 is kept motionless in its position. In particular, it is possible to set a transmission ratio and a spring with an elastic constant so that each pedal stroke results in a predetermined angular displacement of roller 4.

During the rotation the surface of roller 4 skimmingly slides on scraper 5, and any trace of human waste present on the surface is removed in a few passages.

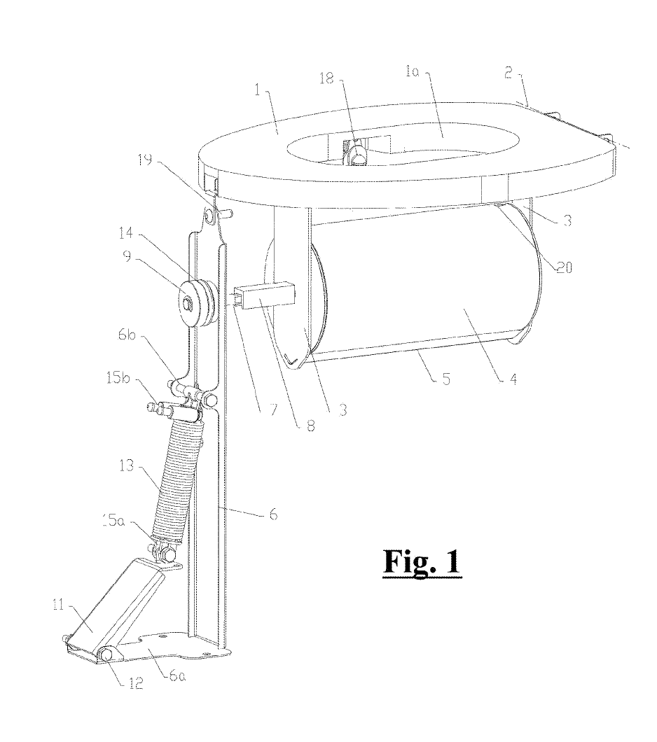

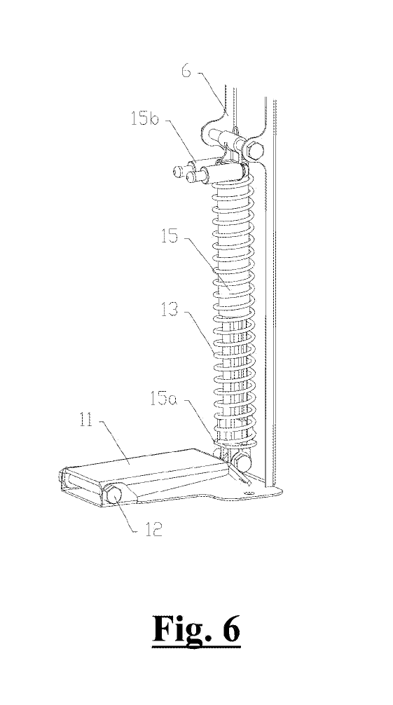

Pump 15 operates cyclically as a result of the pedal drive/release sequence, involving a cleansing/sanitizing liquid loading step, when pedal 11 is depressed (starting from a first end-stroke state, shown in FIG. 1) and roller 4 rotates, and a dispensing step, when pedal 11 is released (starting from a second end-stroke state, shown in FIG. 6) and roller 4 is stationary. When pedal 11 is in a rest position, i.e. when it is not depressed, for example as in the position shown in FIG. 1, pump 15 is empty. When pedal 11 is depressed, a negative pressure to suck liquid in the cylinder is formed in the pump 15; when pressure on pedal 11 stops, pump 15 starts the dispensing step and directs liquid to the dispensing nozzle 18 via conduit 17. From dispensing nozzle 18 liquid is sprayed and evenly distributed on roller 4, to cleanse and sanitize the surface thereof at the end of each use of the sanitary appliance.

It will be appreciated that, by only driving pedal 11, the user can both rotate roller 4 to remove any residual waste and drive pump 15 that, when roller 4 is stationary, cleanses the roller surface and sanitizes the sanitary appliance.

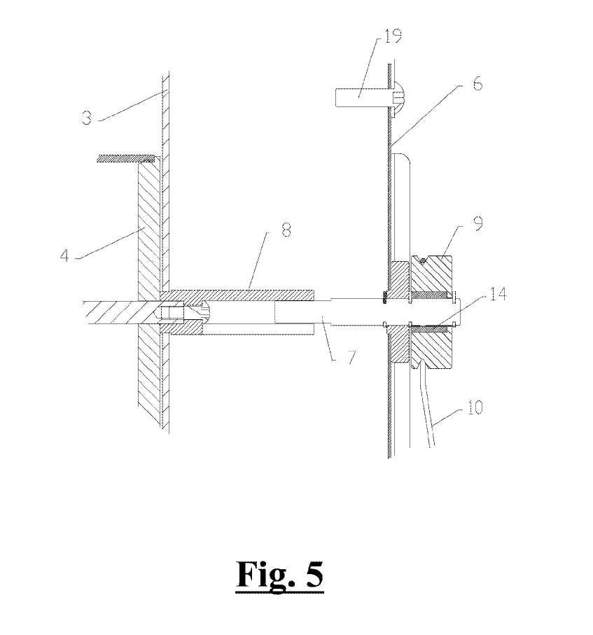

The transmission joint 8 is configured for quickly disconnect roller 4 from transmission shaft 7. To that end, as shown in detail in FIG. 5, the joint is formed with a substantially C-shaped profiled section, and therefore a portion of its profile is open, so that the transmission shaft 7 can pass through the open portion, when roller 4 has to be raised for the maintenance operations. In particular, the operation is necessary when the device of the invention is mounted on a sanitary appliance equipped with a waste collection tank that must be periodically emptied and roller 4 is placed at the inlet of the tank to hide the inside thereof from sight. In this case, seat 1 and roller 4 integral thereto will be lifted, thus clearing the tank inlet and allowing access thereto.

In order to gain access to the waste collecting tank, maintenance staff must align a reference mark 20 formed on the surface of roller 4 to a corresponding fixed reference mark (not shown) formed, for example, along one of the brackets 3. In this condition, the opening of the C-shaped profile of transmission joint 8 is directed downwardly, in the position shown in FIG. 5, for example, and thus it is possible to disengage shaft 7 from the joint by rotating seat 1 about axis 2 to lift it. To that end, the operator must repeatedly depress pedal 11 until both reference marks are put into alignment to one another.

At the end of the maintenance operation the operator must align again the reference marks of the roller and the bracket, lower the seat and perform the first pedal depression; at this point the firm connection between joint 8 and transmission shaft 7 is again ensured, whereby the seat cannot be raised, and normal operation of the whole system is restored.

It is worth pointing out that, in the device according to the invention, working pedal 11 serves not only to the user to clean the roller after use, but also to maintenance staff for the periodical waste collecting tank emptying service.

In one embodiment of the invention, the cleansing and sanitizing liquid tank may consist of a disposable sack. This is required to prevent the maintenance staff from replacing the liquid with just water, which may be full of impurities, thus failing the sanitization surety and risking to endanger the operation system of the pump and dispensing nozzle. The disposable sack may be provided with an inlet point where the pump suction pipe will be inserted.

In another embodiment, a case may be provided to cover and protect the abovementioned transmission members and liquid disposable sack. The case will be arranged at the front part of the sanitary appliance and will cover upright 6, pump 15, pulley 9 and any other component but the portion to be depressed to work the pedal. Locking of the case will be ensured by lock up means placed at the upper part thereof engaging with hook means integral to the upright. The only person authorized to open the case must be the maintenance staff, and this will be required only to check and, if it is the case, replace the cleansing/sanitizing liquid sack and carry out special maintenance works to the operating mechanism.

From the foregoing, it is apparent that the device according to the invention fully achieves the stated objects. The structure of the device is extremely simple to make and assemble and, at the same time, strong and effective in keeping the sanitary appliance in suitable hygiene conditions and allowing the appliance to be maintained in an easy and quick way. Its operation is simple and easy to understand, it being sufficient to depress the pedal several times until the roller is thoroughly cleaned, which can be visually checked.

A number of variations and modifications can be made to the device according to the present invention. For example, the pedal working device can be replaced by a lever working device, or other equivalent driving device. Likewise, the means for transmitting the motion to the roller can be different from those shown and can be selected by the person skilled in the art among those known for performing the same function. The above and other modifications and variations the person skilled in the art can be provide must be all encompassed within the scope of the present invention as defined in the appended claims.

1. A waste material discharging device in a sanitary appliance comprising:
a seat;
a vessel, to which said seat is pivotally connected, having an opening for conveying and collecting said waste material;
a roller rotatable in only one direction about an axis thereof, said roller being integrally connected to said seat and placed therebelow at said opening;
a scraping means stationarily arranged parallel to said roller and substantially in contact to a surface of said roller;
a driving means, operable by a user, for driving unidirectional and intermittent, axial angular displacements to said roller; and
a means for dispensing a cleansing and sanitizing liquid, directed toward the surface of said roller and driven by the driving means.

2. The device according to claim 1, wherein said driving means comprises a pedal pivotally connected to a fixed base and angularly displaceable by pressure in opposition to an elastic means, free wheel transmission means being provided between said pedal and said roller for causing said roller to perform said intermittent, axial angular displacements following corresponding angular displacements of said pedal.

3. The device according to claim 2, wherein said transmission means comprises a pulley in conjunction with a free wheel fitted together with a transmission shaft coaxial to said roller and connected thereto, and a flexible transmission member engaging with said pulley and connected to said pedal.

4. The device according to claim 3, wherein said transmission shaft is connected to said roller through a transmission joint integral to said roller and having a cross-section with a substantially C-shaped profile, an open part of said profile being configured to allow said shaft to be disengaged from said joint.

5. The device according to claim 3, wherein an upright extends from said base for supporting said transmission shaft, said flexible transmission member being fixed to said upright with an end thereof, another end of said flexible transmission member being fixed to said pedal.

6. The device according to claim 1, wherein brackets extend from said seat for supporting said roller and said scraping means.

7. The device according to claim 1, wherein said liquid dispensing means comprises a pump and a dispensing nozzle in fluid communication with said pump, said pump being configured to suck liquid from a reservoir of said liquid when said roller is rotating and to dispense the liquid through said nozzle when said roller is stationary.

8. The device according to claim 7, wherein said pump is a piston type pump and said pump is supported by said upright and said pump is arranged coaxially to said elastic means with the piston rod connected to said pedal.

9. The device according to claim 4, wherein a reference mark is formed on said roller, said reference mark corresponding with a fixed reference mark to indicate a condition wherein the open part of said substantially C-shaped profile of said joint is facing downwards, whereby said shaft is allowed to be disengaged from said joint following an upward movement of said seat.
